(19) United States
(12) Patent Application Publication
(10) Pub. No.: US 2023/0398560 A1
(43) Pub. Date: Dec. 14, 2023

(54) Nozzle for Spraying Substances and Method for the Open-Loop or Closed-Loop Control of the Nozzle

(71) Applicant: Glatt Gesellschaft mit beschränkter Haftung, Binzen (DE)

(72) Inventors: Reinhard Nowak, Lörrach (DE); Jochen Thies, Lörrach (DE)

(21) Appl. No.: 18/249,453

(22) PCT Filed: Oct. 6, 2021
(86) PCT No.: PCT/EP2021/077508

§ 371 Date: Apr. 18, 2023

(30) Foreign Application Priority Data
Oct. 19, 2020 (DE) 10 2020 213 179.1

(51) Int. Cl. B05B 7/06; B05B 7/10; B05B 7/12

(52) U.S. Cl. CPC B05B 7/066; B05B 7/10; B05B 7/1209; B05B 7/1263

(57) ABSTRACT

A nozzle for spraying substances, more particularly dispersions, emulsions or suspensions, and to a method for the open-loop or closed-loop control of the volumetric flow rate of a substance to be sprayed and/or of a gas of a nozzle suitable for spraying substances, more particularly dispersions, emulsions or suspensions. The nozzle includes an inner tube discharge opening and a constriction in an inner tube channel carrying the substance to be sprayed at a distance from the inner tube discharge opening.

### CROSS-REFERENCE TO RELATED APPLICATIONS

This application is the United States national phase of International Application No. PCT/EP2021/077508 filed Oct. 6, 2021, and claims priority to German Patent Application No. 10 2020 213 179.1 filed Oct. 19, 2020, the disclosures of which are hereby incorporated by reference in their entireties.

### BACKGROUND

### Field

The invention relates to a nozzle for spraying substances, in particular dispersions, emulsions or suspensions, the nozzle comprising a nozzle body having a nozzle tip and a longitudinal axis, wherein the nozzle body has an inner tube connected to a feed for the substance to be sprayed and equipped with an inner tube channel comprising an inner tube channel inner wall and an inner tube channel cross-section having an inner tube channel cross-sectional area, and with an inner tube discharge opening having an inner tube discharge opening area, and an outer tube enclosing the inner tube at a radial distance and connected to a feed for a gas, comprising an outer tube discharge opening having an outer tube discharge opening area, and wherein the inner tube discharge opening and the outer tube discharge opening are located in the region of the nozzle tip.

The invention further relates to a method for the open-loop or closed-loop control of the volumetric flow rate of a substance to be sprayed and/or of a gas of a nozzle suitable for spraying substances, in particular dispersions, emulsions or suspensions, wherein the nozzle comprises a nozzle body having a nozzle tip and a longitudinal axis, wherein the nozzle body has an inner tube connected to a feed for the substance to be sprayed and equipped with an inner tube channel comprising an inner tube channel inner wall and an inner tube channel cross-section having an inner tube channel cross-sectional area, and with an inner tube discharge opening having an inner tube discharge opening area, and an outer tube enclosing the inner tube at a radial distance and connected to a feed for a gas, comprising an outer tube discharge opening having an outer tube discharge opening area, and wherein the inner tube discharge opening and the outer tube discharge opening are located in the region of the nozzle tip.

### Description of Related Art

In industrial processes, such as granulating, the coating of tablets or pellets and the direct production of pellets, nozzles or spray nozzles are used very often. In this process the particles are covered by a coating and/or a film. As a rule liquids in which solids are dissolved or suspended are sprayed. These spraying processes can last several hours. The liquid jet is turned into small droplets by atomising. The droplet size generated in this process is of essential importance for the production and/or spraying process. If the droplets are too small, there is a risk that they dry out before reaching their target, and if the droplets are too large, there is a risk of unwanted agglomerates. The process-related eddies in front of the nozzle can—in particular in prolonged spraying processes—result in deposits at the nozzle opening, a so-called “bearding”. These deposits affect the symmetry and the droplet size of the spray, resulting in unwanted process outcomes, such as spray drying and/or local over-moistening and agglomeration.

The prior art referred to below represents technical solutions which prevent or at least minimise unwanted deposits at the nozzle, in particular at the nozzle tip.

The European Patent Specification EP 1 497 034 B1 shows a self-cleaning spray nozzle and in particular a self-cleaning nozzle for use in a device for preparing a particle material by means of a controlled agglomeration method. The self-cleaning nozzle has a central tube having a central aperture for supplying a liquid, wherein the aperture terminates in an opening for dispensing the liquid, a second tube surrounding the central tube, whereby a first aperture is formed between the central tube and the second tube for supplying primary air, a nozzle cone formed at the end of the second tube and forming the outer circumference of a first outlet gap of the first aperture, whereby air supplied through the first aperture is mixed with the liquid to form a liquid/air spray mist, a third tube surrounding the second tube, whereby a second aperture is formed between the second and the third tube for supplying secondary air, a sleeve formed at the end of the third tube and forming the outer circumference of a second outlet gap of the second aperture, the nozzle cone being adjustably located at the end of the second tube for adjusting the size of the first outlet gap.

In the International Patent Application WO 2013/010930 A1 a self-cleaning nozzle for spraying a fluid, having a nozzle housing and a multi-part nozzle head located therein and enclosing a flow channel with a discharge opening for the fluid is described, wherein the nozzle head has at least one fixed and at least one displaceably mounted head element, each of which forms a section of the discharge opening, wherein the displaceable head element is during normal operation pressed by the fluid pressure against a stop located in the flow direction of the fluid and during the self-cleaning process at reduced fluid pressure pressed against the flow direction by a spring.

The published patent application DE 43 24 731 A1 shows a self-cleaning spray nozzle for spraying a fluid from a pressure medium source, wherein a tubular fitting is provided which has an inner fluid channel extending in its longitudinal direction and provided with an inlet and an outlet and which is provided with connecting devices for establishing a connection to the pressure medium source; a tubular shank with an inlet and an outlet, through which the fluid can be passed, wherein the inlet of the shank partially extends into the outlet-side end of the fitting in such a way that the fluid entering the fitting flows through the shank, which is provided with a flange, in the longitudinal direction; wherein a valve seat is provided, having an apron with an inner surface dimensioned such that it fits slidably around the shank and has an outer surface dimensioned such that it fits into the outlet of the tubular fitting in order to fix the radial position of the valve seat, wherein the valve seat furthermore has a lip dimensioned such that it positions the valve seat in the longitudinal direction at the outlet of the tubular fitting and forms a seal between the valve seat and the outlet of the tubular fitting, whereby the valve seat is held in forced contact with the fitting in order to prevent a displacement of the valve seat in the longitudinal direction and in the radial direction; wherein a spray head is provided, having fastening devices for fastening the tubular shank, wherein the spray head comprises outlet devices and has a surface matched to the valve seat; wherein a spring is provided which surrounds the shank and is preloaded against the flange of the shank in order to generate a precisely predetermined preloading force against the valve seat, wherein the spring presses the valve seat against the matched surface of the spray head, so that a seal is formed between the valve seat and the matched surface of the spray head in order to restrict the fluid flow at said seal, and wherein the outlet devices form such a channel for the fluid flow that it is dispersed or sprayed in accordance with a predetermined pattern, wherein a force applied at the spray head and sufficient to overcome the spring preload separates the spray head from the valve seat, whereby the sealing action is cancelled and a purging of the outlet devices by the fluid is made possible.

The Patent Specification DE 101 16 051 B4 discloses a spray nozzle for fluidised bed systems, consisting of a nozzle body, a nozzle cap, at least one discharge opening for a liquid containing solids and at least one discharge opening for a gas, wherein a flexible cleaning cap is arranged around the nozzle cap and, between the nozzle cap and the cleaning cap, there is provided a feed consisting of a compressed air channel located in the nozzle body for a pressurised cleaning air, wherein the compressed air channel is connected to an annular trepan in the outer surface of the nozzle cap via an annular trepan in the outer surface of the nozzle body and at least one transverse bore in the nozzle cap. The cleaning cap directly bears tightly against the nozzle cap. Compressed cleaning air is supplied through the compressed air channel at adjustable different intervals or over a longer period of time. The cleaning air is supplied via the annular trepan and the transverse bore of the annular trepan. Via the annular trepan the cleaning air is supplied over the entire circumference between the nozzle cap and the cleaning cap. By the pressure surge of the cleaning air, the cleaning cap consisting of an elastic material is made to bulge outwards, so that the cleaning air is conducted between the outer surface of the nozzle cap and the inner surface of the cleaning cap towards the discharge opening of the spray nozzle. The cleaning air is directed as a pressure jet to the nozzle orifice of the spray nozzle in an annular fashion from all sides, so that the impulse of the jet can be used directly without loss, and turbulence can be avoided. Any material deposits in the immediate region of the discharge opening in the spray nozzle are blown away by the cleaning air.

### SUMMARY

The above-mentioned technical solutions have the disadvantage that each of the self-cleaning nozzles of prior art has a great number of individual components which are assembled into complex, maintenance-intensive nozzles, making the illustrated technical solutions expensive in their production and maintenance.

The invention is therefore based on the problem of providing a low-cost self-cleaning nozzle which is easy to make and to produce and avoids the disadvantages of prior art.

In a nozzle of the type referred to at the beginning, this problem is solved by providing that a constriction is provided in the inner tube channel carrying the substance to be sprayed at a distance from the inner tube discharge opening, wherein the inner tube channel cross-sectional area is smaller in the constriction than the inner tube channel cross-sectional area of an inner tube channel discharge section between the constriction and the inner tube discharge opening. This design of the nozzle has the advantage that deposit build-up is greatly reduced at the nozzle tip, in particular at the inner tube discharge opening, and/or the outer tube, and at the same time a nozzle consisting of very few components is provided. In addition, the constriction in the nozzle builds up a defined pressure required for spraying/atomising, which is applied to the constriction discharge opening. The constriction thus corresponds to a nozzle opening which adjusts the droplet size, in particular the droplet diameter. It was surprisingly found that this very important characteristic is not influenced by an inner tube discharge opening larger than the constriction discharge opening (nozzle opening).

According to a configuration of the nozzle which is advantageous in this respect, the constriction is designed as an inner tube channel section having an inner tube channel section length. This further increases the pressure in the substance to be sprayed, in particular dispersions, emulsions or suspensions, which significantly improves the entire spraying process. The inner tube channel section preferably has a constant inner tube channel cross-sectional area along the inner tube channel section length or an inner tube channel cross-sectional area decreasing in the flow direction of the substance to be sprayed. By the inner tube channel cross-sectional area decreasing in the flow direction of the substance to be sprayed, the flowing-in behaviour of the substance to be sprayed is improved by reducing turbulences, thereby optimising the spraying process downstream of the constriction.

According to an additional advantageous further development of the nozzle, the constriction has a constriction discharge opening, wherein the inner tube channel cross-sectional area widens in the flow direction of the substance to be sprayed along a constriction flowing-out length. In the course of this the substance to be sprayed is given a smaller target for deposit build-up in the spraying process, which is therefore minimised.

Furthermore, according to an additional advantageous further development of the nozzle, the inner tube and the outer tube are arranged coaxially around a longitudinal axis. In a particularly preferred design, the inner tube and the outer tube are arranged in such a way relative to each other that the inner tube discharge opening is concentric with the outer tube discharge opening. This significantly improves the guidance of the flow, in particular the flow of the gas, in an annular gap, so that the spray symmetry and the droplet size can be adjusted better.

In addition, according to an additional advantageous further development of the nozzle, an add-on part in the form of swirl bodies, swirl plates or the like for gas guidance is located in the region of the nozzle tip between the inner tube and the outer tube. In this respect the add-on part is preferably located in the outer tube for the guidance of the inner tube. In addition, in a particularly preferred design the add-on part is permanently joined to the inner tube and/or the outer tube. By installing an add-on part in the form of swirl bodies, swirl plates or the like, the flow control of the gas, in particular the atomising air, can be influenced at the nozzle tip. In this way the movement and oscillation behaviour of the nozzle tip can be changed in particular, so that deposit build-up at the nozzle tip is minimised. In addition, the spray symmetry and the droplet size of the spray, i.e. the liquid to be atomised, can be adjusted directly. Furthermore, the inner tube is guided in the outer tube in the installation process and always held in the desired position. In addition, the add-on part prevents a vibration of the inner tube, leading to a change of the dimensions of the inner tube discharge opening and the outer tube discharge opening, which changes the flow conditions of the substance to be sprayed and of the gas at the nozzle tip, and thus the spray symmetry and the droplet size as well.

According to an additional advantageous further development of the nozzle, the constriction is formed from a flexible material. In this respect the flexible material advantageously is a polymer, preferably a synthetic polymer, in particular a silicone. Polymers are versatile materials which can be produced cost-effectively, are very robust and, depending on polymer type, highly heat-resistant. The polymers, in particular the synthetic polymers, are therefore highly suitable as a flexible material for the constriction and the various substances to be sprayed.

A fluid chamber having a chamber volume and suitable for receiving and discharging fluid is expediently provided in and/or at the flexible material, so that the inner tube channel cross-sectional area can be adjusted in the constriction.

In a further preferred design, the inner tube is of a multi-part design. This provides the opportunity for producing the constriction separately and/or for producing the constriction from a flexible material and then integrating it into the inner tube. The preferred nozzle is expediently used in a fluidisation apparatus or a coating device.

The individual components of the nozzle, in particular the inner and the outer tube, are preferably produced in an injection moulding process. This creates a cost-effective and low-weight plastic alternative to the conventional metal nozzles. Even the entire nozzle is expediently produced in one piece in an injection moulding process, which represents a significant improvement compared to conventional nozzles, because assembly errors are avoided on the one hand and the nozzle becomes a disposable nozzle on the other hand, i.e. a cleaning of the nozzle is no longer required. These disposable nozzles are replaced after use. For this a special plastic is used, the surface quality characteristics of which minimise built-up deposits.

According to a relevant configuration of the preferred nozzle, fluid chambers having a chamber volume and suitable for receiving and discharging fluid are provided in and/or at the flexible material, so that the inner tube channel cross-sectional area can be adjusted in the constriction and/or an outer tube channel cross-sectional area can be adjusted in the outer tube. The independently adjustable inner tube channel cross-sectional area or outer tube channel cross-sectional area offer the advantage of adjusting the volumetric flow rates of the substance to be sprayed independently of the gas, in particular the atomised gas such as air, and thus reacting individually to the process conditions changing during the process.

In addition, in a method of the type referred to at the beginning, this problem is solved by providing that a constriction is provided in the inner tube channel carrying the substance to be sprayed at a distance from the inner tube, wherein the inner tube channel cross-sectional area is smaller in the constriction than the inner tube channel cross-sectional area of an inner tube channel discharge section between the constriction and the inner tube discharge opening and wherein the constriction is formed from a flexible material, wherein the constriction has a closed position for closing the inner tube channel and at least one open position, wherein the substance to be sprayed can flow at least through the inner tube channel in the at least one open position, wherein a fluid chamber having a chamber volume and suitable for receiving and discharging fluid is provided in and/or at the flexible material, so that the inner tube channel cross-sectional area can be adjusted in the constriction, whereby the nozzle can be or is transferred from the one closed position of the inner tube channel into the at least one open position of the inner tube channel and vice versa. The advantage of the preferred method lies in the fact that the volumetric flow rate of the substance to be sprayed becomes optimally adjustable to the requirements of the running process, in particular with respect to the droplet size of the substance to be sprayed.

According to a method which is advantageous in this respect, when the constriction is transferred from the one closed position of the inner tube channel into the at least one open position of the inner tube channel, the gas flowing though the other tube starts to flow through the outer tube at the same time as the constriction is transferred from the one closed position of the inner tube channel into the at least one open position of the inner tube channel. The method advantageously ensures that, when the spraying process is started at the nozzle tip, i.e. the inner tube discharge opening and the outer tube discharge opening, no substance to be sprayed emerges without being directly atomised by the gas flowing through the annular gap. Atomisation is thus always ensured. There are therefore on the one hand no built-up deposits at the nozzle tip while the prematurely discharged substance to be sprayed dries, and on the other hand there is no agglomeration of particles to be sprayed due to the substance to be sprayed not having been atomised.

When the constriction is transferred from the one closed position of the inner tube channel into the at least one open position of the inner tube channel, the gas flowing through the outer tube preferably begins to flow through the outer tube before the constriction is transferred from the one closed position of the inner tube channel into the at least one open position of the inner tube channel. This further optimises the addition of the substance to be sprayed to the effect that no substance to be sprayed emerges without being directly atomised by the gas flowing through the annular gap. Atomisation is thus likewise always ensured, wherein the gas flowing through the annular gap—atomising gas—has already adjusted itself to the correct volumetric flow rate for the substance to be sprayed, whereby deposits at the nozzle tip or agglomerations of particles to be sprayed due to the substance to be sprayed not having been atomised are securely prevented.

According to an additional advantageous further development of the preferred method, when the constriction is transferred from the at least one open position of the inner tube channel into the one closed position of the inner tube channel, the gas flowing through the outer tube ceases to flow through the outer tube at the earliest at the same time as the constriction is transferred from the at least one open position of the inner tube channel into the one closed position of the inner tube channel. It is particularly preferred if, when the constriction is transferred from the at least one open position of the inner tube channel into the one closed position of the inner tube channel, the gas flowing through the outer tube ceases to flow through the outer tube at the earliest after the constriction has been transferred from the at least one open position of the inner tube channel into the one closed position of the inner tube channel. This method ensures that even at the end of a spraying process all of the substance to be sprayed and emerging from the discharge opening of the inner tube in the region of the nozzle tip is always atomised by the gas flowing through the annular gap.

According to an additional advantageous further development of the method, the chamber volume of the fluid chamber can be or is changed continuously by receiving or discharging fluid, or the chamber volumes can be or are changed continuously by receiving fluid or discharging fluid. In this respect the chamber volumes of the fluid chambers can be or are changed independently of one another by receiving fluid or discharging fluid. It is particularly preferred if the chamber volume or the chamber volumes of the respective fluid chamber can be or is/are changed independently of one another by receiving fluid or discharging fluid. Owing to the continuous adjustability of the chamber volume of the fluid chamber of the constriction or of the chamber volumes of the fluid chambers, it is possible to adjust the volumetric flow rates of the substance to be sprayed and of the gas atomising the substance to be sprayed precisely and in a targeted manner, so that the symmetry and the droplet size of the spray can be or are adjusted optimally for the respective process, in particular a coating process of particles, preferably tablets. The independent adjustability of the chamber volume or volumes also facilitates an optimal adaptation of the volumetric flow rate of the substance to be sprayed to the atomising gas and vice versa. This makes it possible to react even to the smallest changes in the symmetry or droplet size in the spray.

In this respect the several fluid chambers are preferably selectable in such a way that the inner tube channel of the inner tube and the outer tube can be opened up or closed independently of each other. The independently selectable fluid chambers allow the inner tube channel cross-sectional area and the outer tube channel cross-sectional area to be changed independently of each other, so that the volumetric flow rate of the substance to be sprayed can be adjusted independently of the gas, in particular an atomising gas such as air, in order to react individually to process conditions changing during the process.

### BRIEF DESCRIPTION OF THE DRAWINGS

The invention is explained in greater detail below with reference to the accompanying drawing, in which:

FIG. 1 is a sectional illustration of a first embodiment of a preferred nozzle,

FIG. 2 is a top view of the nozzle tip of the first embodiment of the preferred nozzle,

FIG. 3 is a sectional illustration of a second embodiment of a preferred nozzle with a constriction in a first open position,

FIG. 4 is a sectional illustration of the second embodiment of the preferred nozzle with the constriction in a second open position,

FIG. 5 is a sectional illustration of the second embodiment of the preferred nozzle with the constriction in a closed position, wherein both the inner tube channel and the annular gap are closed in the closed position,

FIG. 6 is a sectional illustration of a third embodiment of a preferred nozzle with the constriction in a first open position and with an add-on part, wherein a constriction designed as an inner tube channel section having an inner tube channel section length and wherein the inner tube channel section has a decreasing inner tube channel cross-sectional area along the inner tube channel length in the flow direction of the substance to be sprayed,

FIG. 7 is a sectional illustration of a fourth embodiment of a preferred nozzle with several fluid chambers located in the region of the constriction, the constriction being shown in an open position, and

FIG. 8 is a sectional illustration of a fifth embodiment of a preferred nozzle with several fluid chambers located in the region of the constriction, wherein the constriction is in an open position and the fluid chambers adjust either an inner tube channel discharge opening area or an outer tube channel discharge opening area.

### DETAILED DESCRIPTION

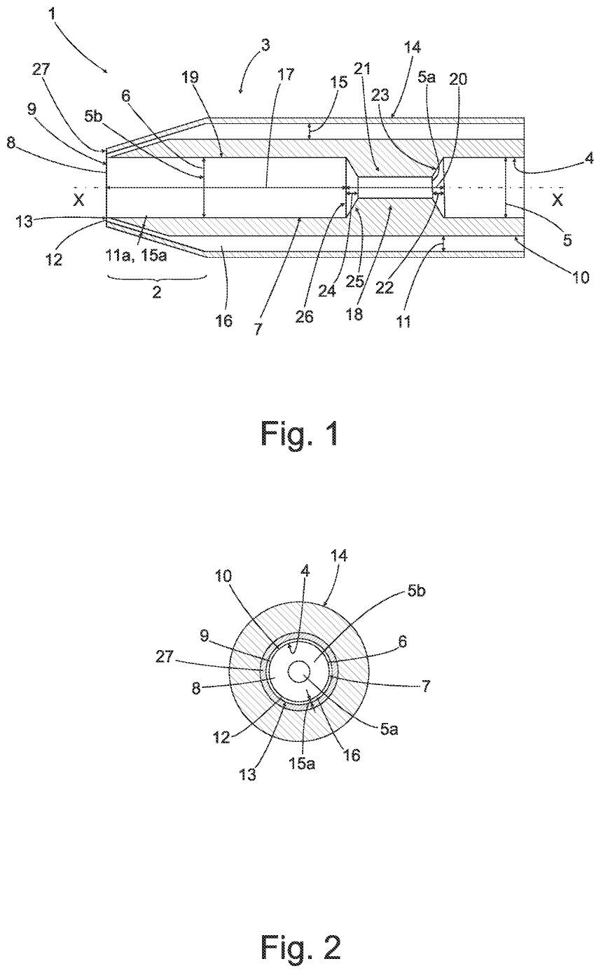

Unless specified otherwise, the following description relates to all embodiments of a nozzle 1 according to the invention for spraying substances and/or of a method according to the invention for the open-loop or closed-loop control of the volumetric flow rate of a substance to be sprayed and/or of a gas of a nozzle 1 suitable for spraying substances, in particular dispersions, emulsions or suspensions, as illustrated in the drawing. FIG. 1 is a sectional illustration of a first embodiment of a preferred nozzle 1.

The nozzle 1 for atomising substances, in particular dispersions, emulsions or suspensions, comprises a nozzle body 3 having a nozzle tip 2 and a longitudinal axis X-X. The nozzle body 3 has an inner tube 10, which is connected to a feed for the substance to be sprayed and has an inner tube channel inner wall 4, an inner tube channel 7 with an inner tube channel cross-section 6 having an inner tube channel cross-sectional area 5 and an inner tube 10 with an inner tube discharge opening 9 having an inner tube discharge opening area 8. The inner tube 10 of the nozzle 1 is designed in one part in the first embodiment, expediently from a plastic material.

The nozzle body 3 has an outer tube 14, which encloses the inner tube 10 at a radial distance 11 and is connected to a feed for a gas and comprises an outer tube discharge opening 13 having an outer tube discharge opening area 12. Between the inner tube 10 and the outer tube 14, an annular gap 16 having an annular gap width 15 is formed. The annular gap width 15a of the annular gap 16 decreases in the region of the nozzle tip 2.

In the illustrated embodiment the inner tube 10 and the outer tube 14 are arranged coaxially around the longitudinal axis X-X, so that the inner tube 10 essentially has the same distance 11 from the outer tube 14 at any position of the longitudinal axis X-X. In the region of the nozzle tip 2 the distance 11a between the inner tube 10 and the outer tube 14 is smaller, corresponding to the reduced annular gap width 15a. In the first embodiment of the preferred nozzle 1 the inner tube 10 and the outer tube 14 are arranged relative to each other in such a way that the inner tube discharge opening 9 is concentric with the outer tube discharge opening 13. Other, non-concentric arrangements of the inner tube discharge opening 9 and the outer tube discharge opening 13 are realised in embodiments not shown in the drawing. In addition, the inner tube discharge opening 9 and the outer tube discharge opening 13 are located in the region of the nozzle tip 2.

In the inner tube channel 7 carrying the substance to be sprayed, a constriction 18 is located at a distance 17 from the inner tube discharge opening 9. In the constriction 18 the inner tube channel cross-sectional area 5a is smaller than the inner tube channel cross-sectional area 5b of an inner tube channel discharge section 19 between the constriction 19 and the inner tube discharge opening 13.

In addition, the constriction 18 is designed as an inner tube channel section 21 having an inner tube channel section length 20 in the illustrated first embodiment. In this the inner tube channel section 21 has a constant inner tube channel cross-sectional area 5a along the inner tube channel section length 20. In another embodiment not shown in the drawing the constriction 18 is designed as an aperture or restrictor, for example.

In addition, the constriction 18 has a constriction inlet section 23 with a constriction inlet length 22 and a constriction outlet section 25 with a constriction outlet length 24. Along a constriction inlet length 22 the inner tube channel cross-sectional area 5 is reduced to the inner tube channel cross-sectional area 5a.

The inner tube channel cross-sectional area 5a increases along the constriction outlet length 24 in the flow direction of the substance to be sprayed to the inner tube channel cross-sectional area 5b. As a result, deposits can form only with great difficulty, if at all, in the region of a constriction outlet opening 26 of the constriction 18, which corresponds to the nozzle opening.

FIG. 2 is a top view of the nozzle tip 12 of the first embodiment of the preferred nozzle 1.

As already described in FIG. 1, the outer tube 14 encloses the inner tube 10. The outer tube 14 has a radial distance from the inner tube 10 having the inner tube channel 7. Between the outer tube 14 and the inner tube 10, the annular gap 14 with the annular gap width 15, through which the gas, in particular the atomising gas, flows, is formed.

The outer tube 14 has a circular outer tube discharge opening 13 with the circular outer tube discharge opening area 12 and an outer tube end face 27.

The deposits having a negative effect on the spray pattern of the nozzle tend to build up at the outer tube end face 27.

The inner tube 10 having the inner tube channel 7 with the inner tube channel inner wall 4 has in the first embodiment the circular inner tube discharge opening 9 with the circular inner tube discharge opening area 8.

In the first embodiment of the preferred nozzle 1 shown in FIG. 2, the inner tube 10 and the outer tube 14 are arranged relative to each other in such a way that the inner tube discharge opening 9 is arranged concentric with the outer tube discharge opening 13.

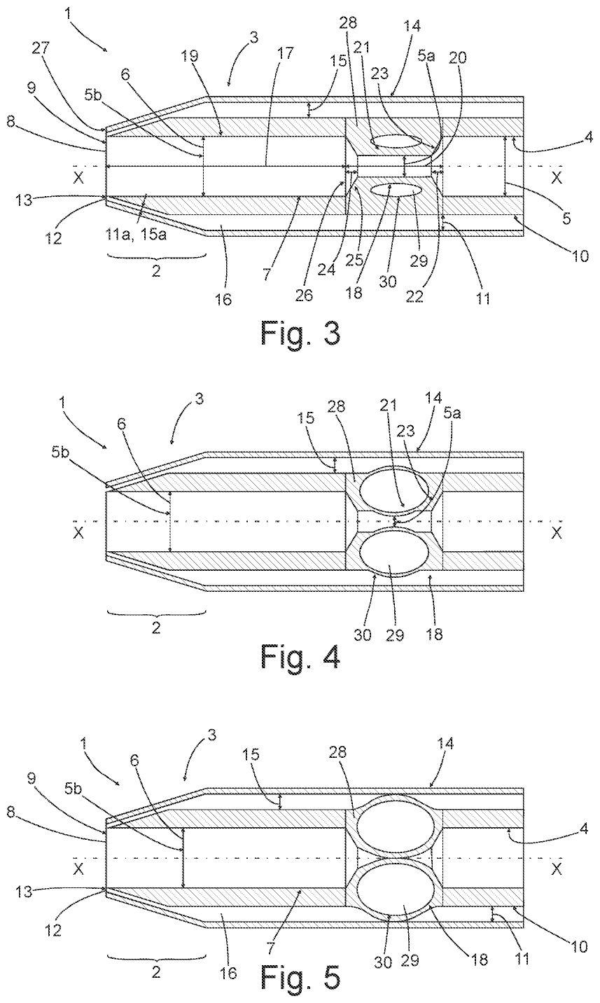

FIG. 3 is a sectional illustration of a second embodiment of a preferred nozzle 1. In contrast to the first embodiment of the nozzle 1 shown in FIGS. 1 and 2, the inner tube of the nozzle 1 is of a multi-part design. The constriction 18 is expediently designed as an inner tube channel section 21 with the inner tube channel section length 20, the constriction 18 being formed from a flexible material 28.

The flexible material 28 expediently is a polymer, preferably a synthetic polymer, in particular a silicone.

A fluid chamber 30 with a chamber volume 29 is located in the flexible material 28. The fluid chamber 30 is suitable for receiving or discharging fluid, so that the inner tube channel cross-sectional area 5a is adjustable in the constriction 18.

This means that, as fluid is received in or discharged from the chamber volume 29 of the fluid chamber 30, a volumetric flow rate of the substance flowing through the inner tube channel 7 is variable and expediently precisely adjustable. In addition, the fluid chamber 30 expediently has a feed line and a discharge line for a fluid adjusting the chamber volume 29, in particular a gas. The chamber volume 29 is increased by receiving fluid and correspondingly reduced by discharging fluid.

In its basic structure the preferred nozzle 1 according to the second embodiment otherwise corresponds to the first embodiment of the preferred nozzle 1.

In the second embodiment shown in FIG. 3, the chamber volume 29 of the fluid chamber 30 is filled in such a way that the nozzle 1 is in a first open position. The chamber volume 29 of the fluid chamber 30 is empty. The inner tube channel cross-sectional area 5a is maximal along the entire inner tube channel section length 20 of the constriction 18 designed as inner tube channel section 21.

FIG. 4 represents a sectional illustration of the second embodiment of the preferred nozzle 1 with the constriction 18 in a second open position. In the second open position the chamber volume 29 of the fluid chamber 30 has been increase by receiving fluid. The increased chamber volume 29 reduces the inner tube channel cross-sectional area 5a and, depending on the design of the flexible material 28, the annular gap width 15 of the annular gap 16 as well. The chamber volume 29 of the fluid chamber 30 is in particular continuously variable by receiving or discharging fluid. As a result it is possible to adjust the volumetric flow rate of the substance to be sprayed and flowing through the inner tube channel 7 and/or of the gas flowing through the annular gap 16 precisely.

In further embodiments the flexible material 28 of the constriction 18 has been designed such that either the substance to be sprayed and flowing through the inner tube channel 7 or the gas flowing through the annular gap 16 is adjustable.

FIG. 5 is a sectional illustration of the second embodiment of the preferred nozzle 1 with the constriction 18 in a closed position, wherein both the inner tube channel 7 and the annular gap 16 are closed.

FIGS. 3 to 5 describe a method for the open-loop or closed-loop control of the volumetric flow rate of a substance to be sprayed and a gas in a nozzle 1 suitable for spraying substances, in particular dispersions, emulsions or suspensions.

The nozzle 1 accordingly has a nozzle body 3 having a nozzle tip 2 and a longitudinal axis X-X. In this the nozzle body 3 comprises an inner tube 10 connected to a feed for the substance to be sprayed and equipped with an inner tube channel 7 comprising an inner tube channel inner wall 4, an inner tube channel cross-section 9 having an inner tube channel cross-sectional area 8, and an inner tube discharge opening 9 having an inner tube discharge opening area 8, and an outer tube 14 enclosing the inner tube 10 at a radial distance and connected to a feed for a gas, comprising an outer tube discharge opening 13 having an outer tube discharge opening area 12.

The inner tube discharge opening 9 and the outer tube discharge opening 13 are located in the region of the nozzle tip 2.

In the inner tube channel 7 carrying the substance to be sprayed, a constriction 18 is located at a distance 17 from the inner tube discharge opening 9, wherein the inner tube channel cross-sectional area 5a is smaller in the constriction 18 than the inner tube channel cross-sectional area 5b of an inner tube channel discharge section 19 between the constriction 18 and the inner tube discharge opening 13. The inner tube 10 is of a multi-part design.

In this the constriction 18 is formed from a flexible material 28, wherein the constriction 18 has a closed position for closing the inner tube channel 7 and at least one open position, wherein the substance to be sprayed can flow through the inner tube channel 7 in the at least one open position. In the region of the constriction 18, a fluid chamber 30 having a fluid chamber volume 29 and suitable for receiving or discharging fluid is located in the flexible material 28, so that the inner tube channel cross-sectional area 5a is adjustable in the constriction 18, whereby the nozzle is transferred from the one closed position of the inner tube channel 7 into the at least one open position of the inner tube channel 7 and vice versa.

While the constriction 18 is transferred from the one closed position of the inner tube channel 7 into the at least one open position of the inner tube channel 7, the gas flowing through the annular gap 16 of the outer tube 14 begins to flow through the outer tube 14 at least at the same time as the transfer of the constriction 18 from the one closed position of the inner tube channel 7 into the at least one open position of the inner tube channel 7. In a preferred configuration of the nozzle 1, the gas flowing through the outer tube 14 begins to flow through the outer tube 14 before the constriction 18 is transferred from the one closed position of the inner tube channel 7 into the at least one open position of the inner tube channel 7.

In addition, while the constriction 18 is transferred from the at least one open position of the inner tube channel 7 to the one closed position of the inner tube channel 7, the gas flowing through the annular gap 16 of the outer tube 14 ceases to flow through the outer tube 14 at the earliest at the same time as the transfer of the constriction 18 from the at least one open position of the inner tube channel 7 to the one closed position of the inner tube channel 7. While the constriction 18 is transferred from the at least one open position of the inner tube channel 7 to the one closed position of the inner tube channel 7, the gas flowing through the annular gap 16 of the outer tube 14 expediently ceases to flow through the outer tube 14 after the transfer of the constriction 18 from the at least one open position of the inner tube channel 7 to the one closed position of the inner tube channel 7.

In the illustrated embodiment the preferred nozzle 1 has a closed position for the inner tube 10 and for the outer tube 14, in particular the annular gap 16, as well. In this both the inner tube 10 and the outer tube 14 can be opened up and closed dependently on each other.

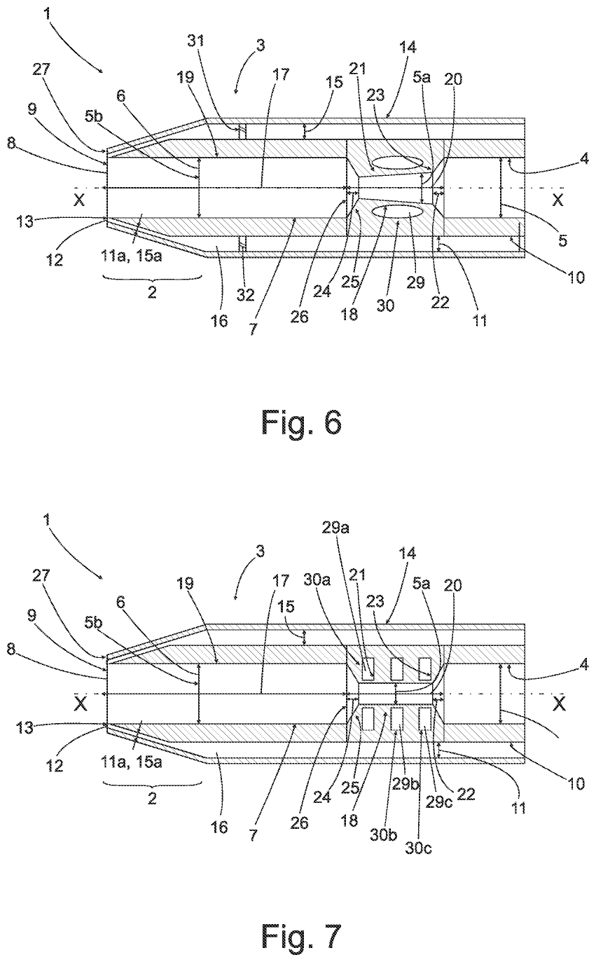

FIG. 6 is a sectional illustration of a third embodiment of a preferred nozzle 1 with a constriction 18 in a first open position and an optional add-on part 29 located in the annular gap 29 between the inner tube 10 and the outer tube 14.

In its basic structure the preferred nozzle 1 according to the third embodiment corresponds to the second embodiment of the preferred nozzle 1 shown in FIGS. 3 to 5. The difference between the two embodiments lies in the fact that the preferred nozzle 1 of the third embodiment has, in contrast to the nozzle 1 of the second embodiment, an optical add-on part 31 designed in the form of a swirl plate for gas guidance. In addition, the constriction 18 is designed as an inner tube channel section 21 having an inner tube channel section length 20, wherein the inner tube channel section 21 has a decreasing inner tube channel cross-sectional area 5a along the inner tube channel section length 20 in the flow direction of the substance to be sprayed.

In the present third embodiment of the preferred nozzle 1, the add-on part 31 has openings 32 at an angle to the gas, in particular an atomising air, flowing parallel to the outer tube 14. As a result, the gas flowing in the annular gap 16 is made to swirl about the longitudinal axis X-X. By the swirl about the longitudinal axis X-X the flow of the substance to be sprayed can be influenced at the outer tube discharge opening 13 of the outer tube 14. As realised in other embodiments not shown in the drawing, the openings 32 can have different angles and openings widths as well. They generate a swirl of the gas, whereby the spray pattern of the spray and thus the droplet size can be adjusted.

The add-on part 31 is preferably located in the region of the nozzle tip 2 between the outer tube 14 and the inner tube 10. In a particularly preferred configuration the add-on part 31 is arranged to guide the inner tube 10.

The add-on part 31 can also be designed in the form of swirl bodies, e.g. flow baffles or the like, for gas guidance. The add-on part 31 is expediently joined permanently to the inner tube 10 and the outer tube 14. This increases the stability of the nozzle 1 in the region of the nozzle tip 2. In addition, by the installation of an add-on part 31 in the form of swirl bodies, swirl plates or the like, the guidance of the flow of gas, in particular atomising air, can be influenced at the nozzle tip 2, in particular in the discharge region of the nozzle 1. Because of this the flow behaviour of the gas flowing through the annular gap 16 can be changed and adjusted precisely at the outer tube discharge opening 13, in order to improve the spray pattern of the nozzle 1 for the production and/or spraying process. In addition, because of this the spray symmetry and the droplet size of the substance to be sprayed, preferably a liquid and particularly preferably a dispersion, emulsion or suspension, can be adjusted directly.

Furthermore, when being installed into the outer tube 14, the inner tube 10 is guided and always held in the desired position—in FIG. 6 in a concentric position about the longitudinal axis X-X. In addition, the add-on part 31 prevents a vibration of the inner tube 10 leading to a change of both the inner tube discharge opening 9 and the outer tube discharge opening 13, which influences the flow conditions at the nozzle tip 2, in particular in the discharge region of the nozzle 1, and thus the spray symmetry and the droplet size of the spray.

FIG. 7 is a sectional illustration of a fourth embodiment of a preferred nozzle 1 with several fluid chambers 30 located in the region of the constriction 18, the constriction 18 being in an open position.

In its basic structure the preferred nozzle 1 according to the fourth embodiment corresponds to the second embodiment of the preferred nozzle 1 shown in FIGS. 3 to 5 as well. The difference between the two embodiments lies in the fact that the preferred nozzle 1 of the fourth embodiment has, in contrast to the nozzle of the second embodiment, several, i.e. three, chamber volumes 29a, 29b, 29c of the fluid chambers 30a, 30b, 30c, which can be changed continuously by receiving or discharging fluid. In other embodiments not shown in the drawing, another number of fluid chambers is realised, e.g. two, four, five, Six etc.

The chamber volumes 29a, 29b, 29c of the fluid chambers 30a, 30b, 30c can expediently be adjusted and/or changed independently of one another by receiving or discharging fluid.

Owing to the continuous adjustability of the chamber volumes 29a, 29b, 29c of the fluid chambers 30a, 30b, 30c, it is possible to adjust the volumetric flow rate of the substance to be sprayed and of the gas atomising the substance to be sprayed precisely and in a targeted manner, so that the symmetry and the droplet size of the spray can be adjusted optimally for the respective process, in particular a coating process of particles, preferably tablets. The independent adjustability of the chamber volumes 29a, 29b, 29c also facilitates an optimal adaptation of the volumetric flow rate of the substance to be sprayed to the atomising gas and vice versa. This makes it possible to react even to the smallest changes in the symmetry or droplet size in the spray.

Other embodiments not shown in the drawing moreover offer the opportunity to activate the several fluid chambers 30 in such a way that either the inner tube channel 7 of the inner tube 10 or the outer tube 14 can be opened up and closed independently of each other.

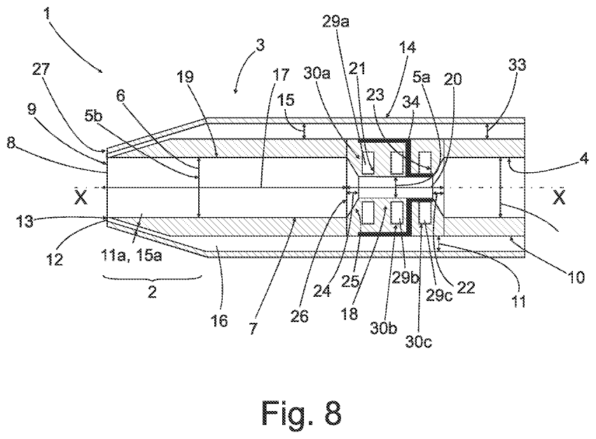

FIG. 8 is a sectional illustration of a fifth embodiment of a preferred nozzle 1 with several fluid chambers 29a to 29c located in the region of the constriction 18, the constriction 18 being in an open position and the fluid chambers 30a to 30c adjusting either an inner tube channel cross-sectional area 5a or an outer tube channel cross-sectional area 33. In this embodiment the outer tube channel cross-sectional area 33 corresponds to an annular gap area.

To this end the nozzle 1 according to the fifth embodiment has furthermore several fluid chambers 30a to 30c with a chamber volume 29a to 29c in and/or at the flexible material 28. The fluid chambers 30a to 30c are suitable for receiving or discharging fluid. Because of this the inner tube channel cross-sectional area 5a in the constriction 18 and/or an outer tube channel cross-sectional area 33 in the outer tube 14 are/is adjustable. In order to prevent a mutual influence of the fluid chambers 30a to 30c, fluid chamber limiting devices 34 are installed between the fluid chambers 30a to 30c, here between the fluid chambers 29a and 29b adjusting the constriction 18 and thus the inner tube channel cross-sectional area 5a on the one hand and the fluid chamber 29c adjusting the outer tube channel cross-sectional area 33 on the other hand.

If fluid is supplied to the chamber volumes 29a and 29b, the fluid chambers 29a and 29b become larger and limit the flow of the substance to be sprayed through the constriction 18 by reducing the inner tube channel cross-sectional area 5a. The outer tube channel cross-sectional area 33 is not affected by this.

The opposite case is possible as well: if fluid is supplied to the chamber volume 29c, the fluid chamber 29c becomes larger and limits the flow of the gas by reducing the outer tube channel cross-sectional area 33. The inner tube channel cross-sectional area 5a is not affected by this.

It is furthermore possible to fill the fluid chambers 30a to 30c independently of one another by activating the fluid volumes 29a to 29c, so that the inner tube channel cross-sectional area 5a and/or the outer tube channel cross-sectional area 33 can be adjusted independently of each other. In this respect the several fluid chambers can be activated in such a way that the inner tube channel 7 of the inner tube 10 or the outer tube 14 can be opened up or closed independently of each other. The independently adjustable inner tube channel cross-sectional area 5a and/or outer tube channel cross-sectional area 33 offer(s) the advantage of adjusting the volumetric flow rates of the substance to be sprayed independently of the gas, in particular an atomising gas such as air, and thus being able to react individually to process conditions changing during the process.

1. A nozzle for spraying substances, the nozzle comprising
a nozzle body having a nozzle tip and a longitudinal axis, wherein the nozzle body has an inner tube connected to a feed for a substance to be sprayed and equipped with an inner tube channel comprising an inner tube channel inner wall and an inner tube channel cross-section having an inner tube channel cross-sectional area, and with an inner tube discharge opening having an inner tube discharge opening area, and an outer tube enclosing the inner tube at a radial distance and connected to a feed for a gas, comprising an outer tube discharge opening having an outer tube discharge opening area, and wherein the inner tube discharge opening and the outer tube discharge opening are located in a region of the nozzle tip,
wherein a constriction is provided in the inner tube channel carrying the substance to be sprayed at a distance from the inner tube discharge opening,
wherein the inner tube channel cross-sectional area is smaller in the constriction than the inner tube channel cross-sectional area of an inner tube channel discharge section between the constriction and the inner tube discharge opening.

2. The nozzle according to claim 1, wherein the constriction is designed as an inner tube channel section having an inner tube channel section length.

3. The nozzle according to claim 2, wherein the inner tube channel section has a constant inner tube channel cross-sectional area along the inner tube channel section length.

4. The nozzle according to claim 2, wherein the inner tube channel section has an inner tube channel cross-sectional area which decreases in the flow direction of the substance to be sprayed.

5. The nozzle according to claim 1, wherein the constriction has a constriction discharge opening, wherein the inner tube channel cross-sectional area widens in the flow direction of the substance to be sprayed along a constriction flowing-out length.

6. The nozzle according to claim 1, wherein the inner tube and the outer tube are arranged coaxially around a longitudinal axis.

7. The nozzle according to claim 1, wherein the inner tube and the outer tube are arranged relative to one another in such a way that the inner tube discharge opening is concentric with the outer tube discharge opening.

8. The nozzle according to claim 1, wherein an add-on part in the form of swirl bodies, swirl plates or the like for gas guidance is located in the region of the nozzle tip between the inner tube and the outer tube.

9. (canceled)

10. (canceled)

11. The nozzle according to claim 1, wherein the constriction is formed from a flexible material.

12. (canceled)

13. The nozzle according to claim 11, wherein a fluid chamber having a chamber volume and suitable for receiving and discharging fluid is provided in and/or at the flexible material, so that the inner tube channel cross-sectional area a can be adjusted in the constriction.

14. The nozzle according to claim 13, wherein several fluid chambers having a chamber volume and suitable for receiving and discharging fluid are provided in and/or at the flexible material, so that the inner tube channel cross-sectional area can be adjusted in the constriction and/or an outer tube channel cross-sectional area can be adjusted in the outer tube.

15. The nozzle according to claim 1, wherein the inner tube is of a multi-part design.

16. A method for the open-loop or closed-loop control of a volumetric flow rate of a substance to be sprayed and/or of a gas of a nozzle suitable for spraying substances, wherein the nozzle comprises a nozzle body having a nozzle tip and a longitudinal axis wherein the nozzle body has an inner tube connected to a feed for the substance to be sprayed and equipped with an inner tube channel comprising an inner tube channel inner wall and an inner tube channel cross-section having an inner tube channel cross-sectional area, and with an inner tube discharge opening having an inner tube discharge opening area, and an outer tube enclosing the inner tube at a radial distance and connected to a feed for a gas, comprising an outer tube discharge opening having an outer tube discharge opening area, and wherein the inner tube discharge opening and the outer tube discharge opening wherein a constriction is provided in the inner tube channel carrying the substance to be sprayed at a distance from the inner tube discharge opening, wherein the inner tube channel cross-sectional area is smaller in the constriction than the inner tube channel cross-sectional area of an inner tube channel discharge section between the constriction and the inner tube discharge opening and wherein the constriction is formed from a flexible material, wherein the constriction has a closed position for closing the inner tube channel and at least one open position, wherein the substance to be sprayed can flow at least through the inner tube channel in the at least one open position, wherein a fluid chamber having a chamber volume and suitable for receiving and discharging fluid is provided in and/or at the flexible material, so that the inner tube channel cross-sectional area can be adjusted in the constriction, whereby the nozzle is transferred from the one closed position of the inner tube channel into the at least one open position of the inner tube channel and vice versa.

17. The method according to claim 16, wherein, when the constriction is transferred from the one closed position of the inner tube channel into the at least one open position of the inner tube channel, the gas flowing though the other tube starts to flow through the outer tube at least at the same time as the constriction is transferred from the one closed position of the inner tube channel into the at least one open position of the inner tube channel.

18. The method according to claim 16, wherein, when the constriction is transferred from the one closed position of the inner tube channel into the at least one open position of the inner tube channel, the gas flowing though the other tube starts to flow through the outer tube before the constriction is transferred from the one closed position of the inner tube channel into the at least one open position of the inner tube channel.

19. The method according to claim 16, wherein, when the constriction is transferred from the at least one open position of the inner tube channel into the one closed position of the inner tube channel, the gas flowing through the outer tube ceases to flow through the outer tube at the earliest at the same time as the constriction is transferred from the at least one open position of the inner tube channel into the one closed position of the inner tube channel.

20. The method according to claim 16, wherein, when the constriction is transferred from the at least one open position of the inner tube channel into the one closed position of the inner tube channel, the gas flowing through the outer tube ceases to flow through the outer tube at the earliest after the constriction has been transferred from the at least one open position of the inner tube channel into the one closed position of the inner tube channel.

21. The method according to claim 16, wherein the chamber volume of the fluid chamber can be or is changed continuously by receiving or discharging fluid, or the chamber volumes of the fluid chambers can be or are changed continuously by receiving fluid or discharging fluid.

22. The method according to claim 21, wherein the chamber volumes of the fluid chambers can be or are changed independently of one another by receiving fluid or discharging fluid.

23. The method according to claim 21, wherein the several fluid chambers are selectable in such a way that the inner tube channel of the inner tube or the outer tube can be opened up or closed independently of each other.
